(19) United States
(12) Patent Application Publication
(10) Pub. No.: US 2023/0022383 A1
(43) Pub. Date: Jan. 26, 2023

(54) SYSTEMS, VEHICLES, AND METHODS FOR ENGAGING A DISCONNECTED AXLE

(71) Applicant: Rivian IP Holdings, LLC, Plymouth, MI (US)

(72) Inventor: Rahul Madineni, Farmington Hills, MI (US)

(21) Appl. No.: 17/380,349

(22) Filed: Jul. 20, 2021

(51) Int. Cl. G01C 21/36; G01C 21/00

(52) U.S. Cl. CPC G01C 21/3602; G01C 21/3841; G01C 21/3815

(57) ABSTRACT

Various disclosed embodiments include illustrative systems, vehicles, and methods. In an illustrative embodiment, a system includes a sensor configured to generate route information, and a control unit. The control unit includes a processor in signal communication with the sensor and a memory configured to store computer-executable instructions. The computer-executable instructions are configured to cause the processor to receive the generated route information, generate a wheel signal responsive to the received route information indicating a change in wheel engagement status, and output the wheel signal to a disconnect.

### INTRODUCTION

The present disclosure relates to vehicle handling. The statements in this section merely provide background information related to the present disclosure and may not constitute prior art.

Some all-wheel drive vehicles may operate in two-wheel drive mode until a loss of traction is sensed, at which time the non-engaged wheels are engaged. Thus, such all-wheel drive functionality is activated responsive to a sensed physical experience.

### BRIEF SUMMARY

Various disclosed embodiments include illustrative systems, vehicles, and methods.

In an illustrative embodiment, a system includes a sensor configured to generate route information, and a control unit. The control unit includes a processor in signal communication with the sensor and a memory configured to store computer-executable instructions. The computer-executable instructions are configured to cause the processor to receive the generated route information, generate a wheel signal responsive to the received route information indicating a change in wheel engagement status, and output the wheel signal to a disconnect.

In another illustrative embodiment, a vehicle includes a sensor, a controller unit, and a disconnect. The sensor may be configured to generate route information. The controller unit includes a processor in signal communication with the sensor and a memory configured to store computer-executable instructions. The computer-executable instructions are configured to cause the processor to receive the generated route information, generate a wheel signal responsive to the received route information indicating a change in wheel engagement status, and output the wheel signal. The disconnect may be configured to apply an action chosen from an engagement action or a disengagement action responsive to the outputted wheel signal.

In another illustrative embodiment, a method includes receiving route information, generating a wheel signal responsive to the route information indicating a change in wheel engagement status, and applying an action chosen from an engagement action or a disengagement action responsive to the generated wheel signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIGS. 1A-C are block diagrams in partial schematic form of illustrative vehicles with illustrative vehicle handling systems.

FIG. 2 is a block diagram of illustrative components of the vehicle handling systems of FIGS. 1A-C.

FIG. 3 is a flow diagram of an illustrative method for controlling vehicle stability.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative systems, vehicles, and methods. In such embodiments, various illustrative systems and methods may contribute to helping control vehicle stability.

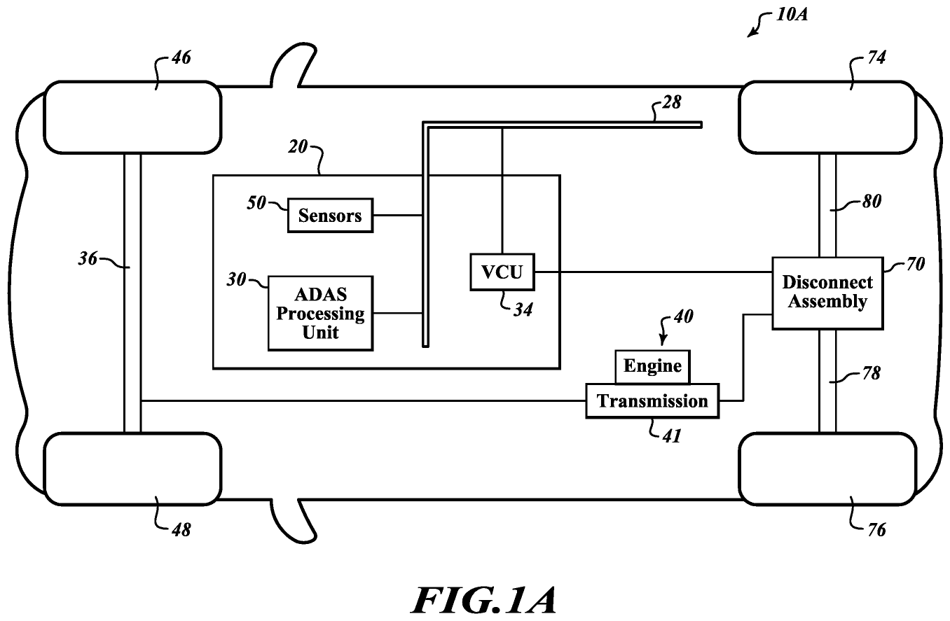

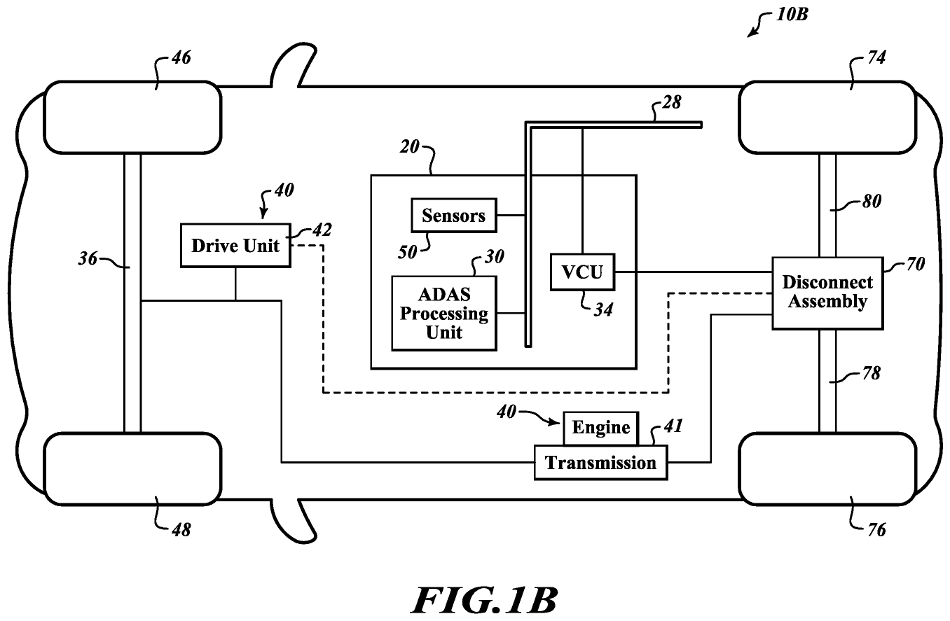

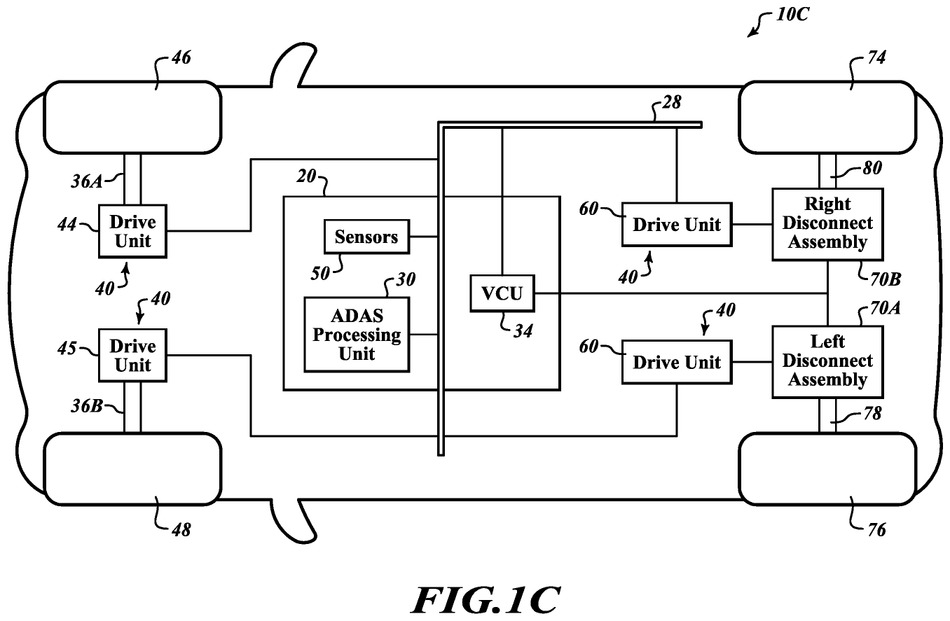

Referring to FIGS. 1A, 1B, and 1C and given by way of overview, in various embodiments an illustrative vehicle, such as a vehicle 10A (FIG. 1A), a vehicle 10B (FIG. 1B) and/or a vehicle 10C (FIG. 1C) is provided. In such embodiments the vehicle includes a system 20 with components for contributing to helping control vehicle stability such as by, for example and without limitation, controlling engagement of wheels responsive to an all-wheel drive condition prediction.

In various embodiments at least one motor 40 provides locomotive force or propulsion force to propel the vehicle. As will be discussed below and as shown in FIG. 1A, in some embodiments the motor 40 may include an internal combustion engine (such as an ignition combustion engine or a compression ignition engine). As will also be discussed below and as shown in FIG. 1B, in some other embodiments the motor 40 may include a hybrid power plant that includes an internal combustion engine (such as an spark ignition engine or a compression ignition engine) and an electric motor. As will also be discussed below and as shown in FIG. 1C, in some other embodiments the motor 40 may include an electric motor. Thus, it will be appreciated that, as used herein, the term “motor” includes any

In various embodiments and as shown in FIG. 1A, the motor 40 is an internal combustion engine that is configured to propel the vehicle 10A. In some such embodiments the motor 40 powers a front axle 36 coupled to front wheels 46 and 48 and a pair of rear axles 78 and 80 coupled to rear wheels 74 and 76 via a transmission 41. A disconnect/disconnect assembly 70 is disposed between the transmission 41 and the pair of rear axles 78 and 80 and is configured to connect or disconnect, and/or selectably connect and disconnect the rear axles 78 and 80 to and from the transmission 41 as desired. In various embodiments, the disconnect 70 may connect to a single shaft that is then coupled to the pair of rear axles 78 and 80 via a coupler, such as without limitation a differential, a slip differential, or the like. In some other embodiments a single rear axle may be used in place of the pair of rear axles 78 and 80. It will be appreciated by one of ordinary skill in the art that in some embodiments the motor 40 may power the rear axle or axles 78 and 80 and the disconnect 70 may be connected to the front axle 36. Transmission connections, disconnects/disconnect assemblies, including differentials and the like are well known in the art and no further explanation is necessary for a person of skill in the art to understand disclosed subject matter.

In various embodiments and as shown in FIG. 1B, an illustrative vehicle 10B is a dual-motor or hybrid electric vehicle. In such embodiments, the vehicle 10B suitably includes the components included in the single-engine vehicle 10A (FIG. 1A). However, in various embodiments the motor 40 of the vehicle 10B includes the internal combustion engine and an electric motor drive unit 42. The electric motor drive unit 42 is coupled to the front axle 36. In some embodiments the electric motor drive unit 42 is also selectably connectable and disconnectable to and from the rear axles 78 and 80 via the disconnect 70 in optional all-wheel drive electric configurations. As in the vehicle 10A (FIG. 1A), in some embodiments a single rear axle may be used in place of the pair of rear axles 78 and 80. It will be appreciated by one of ordinary skill in the art that in some embodiments the motor 40 may power the rear axle or axles 78 and 80 and the disconnect 70 may be connected to the front axle 36.

Referring additionally to FIG. 1C, in various embodiments an illustrative vehicle 10C is an electric vehicle. In such embodiments the vehicle 10C includes two of the motors 40. In some such embodiments, one motor 40 includes front electric motor drive units 44 and 45 that are coupled to the respective front wheels 46 and 48 via front axles 36A and 36B. In some other such embodiments the front electric motor drive units 44 and 45 may be replaced by a single an electric motor drive unit couplable to the front axles 36A and 36B or to a single front axle. In some such embodiments, another motor 40 includes rear electric motor drive units 60 and 62 that are coupled to the respective rear wheels 74 and 76 via rear axles 80 and 78 via the left disconnect 70A and the right disconnect 70B, respectively. In some other such embodiments the rear electric motor drive units 44 and 45 may be replaced by a single an electric motor drive unit couplable to the rear axles 36A and 36B via the disconnects 70A and 70B, respectively, or to a single rear axle via a single disconnect 70.

In various embodiments the system 20 controls operations of at least one disconnect, such as the disconnect 70 (FIGS. 1A and 1B) or the left disconnect 70A and the right disconnect 70B (FIG. 1C). In various embodiments, the system 20 includes an advanced driver assistance system (ADAS) processing unit 30, a vehicle control unit (VCU) 34, and a sensor(s) 50.

In various embodiments the system 20 controls operations of at least one disconnect, such as a disconnect 70 (FIGS. 1A and 1B) or a left disconnect 70A and a right disconnect 70B (FIG. 1C). In various embodiments, the system 20 includes an advanced driver assistance system (ADAS) processing unit 30, a vehicle control unit (VCU) 34, and a sensor(s) 50.

In various embodiments the VCU 34 controls all-wheel drive functionality. The VCU 34 controls power supplied to the wheels 46, 48, 74, and 76 of the vehicles 10A, 10B, and 10C. In certain operational conditions, such as without limitations, cruising speeds, no experienced wheel slippage, or sensed differential torque issues, the VCU 34 disengages two wheels to operate in a more efficient two-wheel drive mode. In some such embodiments and as shown in FIGS. 1A, 1B, and 1C, the two-wheel drive mode is a front-wheel drive mode. However, it will be appreciated that, in some other such embodiments, the two-wheel drive mode is a rear-wheel drive mode. All-wheel drive operations are well known in the art and no further explanation is necessary for a person of skill in the art to understand disclosed subject matter. The below description is given by way of illustration only and not of limitation and relates to re-engaging rear wheels responsive to an all-wheel drive condition prediction during operation in a front-wheel drive mode. However, as mentioned above, it will be appreciated that front wheels may be re-engaged responsive to an all-wheel drive condition prediction during operation in a rear-wheel drive mode.

In various embodiments the ADAS processing unit 30, the sensor(s) 50, and the VCU 34 may communicate via a data bus 28, such as without limitation a controller area network (CAN) bus or the like. Other data buses or peer-to-peer network buses, such as a local area network (LAN), a wide area network (WAN), a value-added network (VAN), or the like may also be used for enabling communication between the components of the vehicle 10 as desired for a particular application.

In various embodiments and given by way of example only and not of limitation, the drive units 60 and 62 may include motor controllers and motors, such as brushless direct current (BLDC) motors, alternating current induction motors (ACIM), permanent magnet synchronous motors (PMSM), interior PM motors (IPMM), PM switch reluctance motors (PMSRM), or comparable battery-powered motors. As mentioned above, the motor 40 may include other types of motors/engines, such as without limitation, a spark ignition engine, a compression ignition engine or the like.

In various embodiments and given by way of example only and not of limitation, the disconnects 70, 70A, and 70B may include gears that are configured to transfer force from the drive units 60 and 62 to the respective wheels 74 and 76 and wheel axles 78 and 80. The disconnects 70, 70A, and 70B may include pocket plates with actuatable struts, multi-clutch plates, clutch motors, differentials with clutch device, or comparable devices that are configured to cause engagement and disengagement between a motor side and an axle side of the disconnects 70, 70A, and 70B. Pocket plates with actuatable struts, multi-clutch plates, and clutch motors are well known in the art and no further explanation is necessary for a person of skill in the art to understand disclosed subject matter.

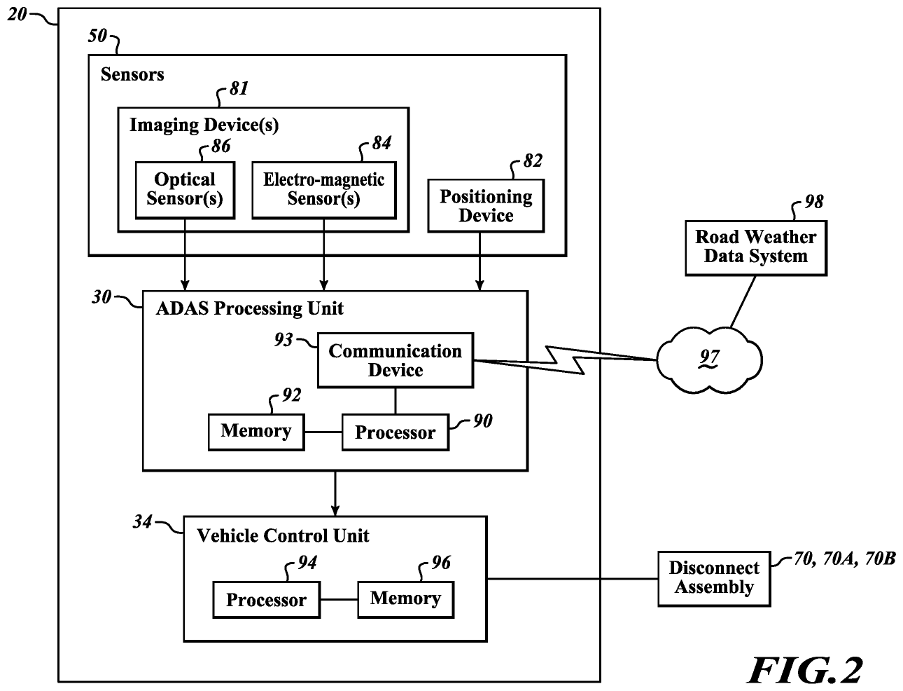

Referring additionally to FIG. 2, in various embodiments the ADAS processing unit 30 includes a processor 90 and a memory 92 configured to store computer-executable instructions. The computer-executable instructions are configured to cause the processor 90 to receive information from the sensor(s) 50 related to a route or a road the vehicle 10 will soon be traveling on and determine a curvature value for the to-be-traveled route or road, where the value may vary based on the terrain under which the vehicles 10A-C may be traveling (e.g., gravel, rock, dirt, sand, etc.) or determine road type, condition, or quality responsive to the received information. It is well known in the art to that sensor data of terrain or objects in front of a vehicle can be categorized as various features, such as other vehicles, pedestrians, trees, roadways, and the like. Analysis of various types of sensor data is well known in the art and no further explanation is necessary for a person of skill in the art to understand the low subject matter.

In various embodiments the sensor(s) 50 may include an imaging device(s) 81 and/or a positioning device(s) 82. The sensor(s) 50 is configured to generate images or data of route information in front of the vehicle 10. Types of sensor(s) 50 are described in more detail below.

In various embodiments the sensor(s) 50 may include one or a combination of different types of sensors. The imaging device(s) 81 may include an optical device(s)/sensor(s) 86, an electromagnetic sensor(s) 84, or the like. In various embodiments and given by way of example only and not of limitation, the optical sensor(s) 86 may include a camera, a light detection and ranging (LIDAR) device, or the like. In various embodiments and given by way of example only and not of limitation, the electromagnetic sensor(s) 84 may include a radar device, sonar device, or the like. In various embodiments and given by way of example only and not of limitation, the positioning device 82 may include a global positioning system (GPS), a global navigation satellite system (GNSS), or the like. In various embodiments, the positioning device 82 may allow a user, via an interface, to enter navigation information, such as, without limitation, a destination, a trip, and the like. The route information is determined by the positioning device 82 from the entered navigation information. The data produced by the GPS and/or the GNSS is inputted to the ADAS processing unit 30. Optical sensors, electromagnetic sensors, and positioning devices are well known in the art and no further explanation is necessary for a person of skill in the art to understand the disclosed subject matter.

In various embodiments the optical sensor(s) 86 is configured to generate digital images of the space in front of the vehicle 10A, 10B, or 10C. The optical sensor(s) 86 may include an automatic zoom function configured to focus of the optical sensor(s) 86 with regards to the space in front of the vehicle 10A, 10B, or 10C. Optical sensors with automatic zoom are well known in the art and no further explanation is necessary for a person of skill in the art to understand disclosed subject matter.

In various embodiments the lidar, the radar, or comparable devices generate return data that includes range values. The positioning device 82 may identify where the vehicle 10A, 10B, or 10C is currently located on a map previously stored with memory associated with or accessible by the positioning device 82. The positioning device 82 may determine speed and direction of travel of the vehicle 10A, 10B, or 10C. The ADAS processing unit 30 may use the digital images, the return data with the range values, the map position information, the speed, and/or the direction of travel information to identify an upcoming route or road and determine a curvature or curvature value for the identified upcoming route or road. It will be appreciated by one of ordinary skill that calculating road curvature for route or road data may be performed various ways, such as, without limitation, identifying a beginning point of a curve of the route or road, identifying a further point along the curve of the route or road, identifying directions of travel (tangents to the curve) for the identified points, and calculating a radius of curvature using the directions of travel and the locations of the identified points.

In various embodiments the VCU 34 may include a processor 94 and a memory 96 configured to store computer-executable instructions. The computer-executable instructions are configured to cause the processor 94 to receive the determined curvature value, generate a wheel signal (e.g., an engage wheel signal or disengage wheel signal) responsive to the received curvature value meeting or exceeding a threshold value, and output the wheel signal to the disconnects 70, 70A, or 70B. The threshold value is a previously identified value selected in response to the knowledge, information, and/or data of how the vehicle 10A, 10B, or 10C responds on road curves of various curvature values or on roads of various conditions. Meeting or exceeding the threshold value indicates that the VCU 34 will affect engagement of the previously disengaged wheels, thus helping contribute to improving stability of the vehicle 10A, 10B, or 10C in the upcoming curve.

In various embodiments the disconnects assemblies 70, 70A, or 70B are configured to apply an action (e.g., an engagement action or disengagement action) responsive to the outputted wheel signal (e.g., engage wheel signal or disengagement wheel signal). Engagement actions include performing speed matching between the motor 40, then mechanically locking or connecting the motor 40 to the respective axle 78 and 80.

In various embodiments the all-wheel drive condition prediction may result from other types of analysis of the data produced by the sensor(s) 50. The VCU 34 may determine that the all-wheel drive condition prediction exists responsive to the sensor data indicating a certain type of road condition, such as, without limitation, snow, rain, texture, or any condition that might cause the vehicle 10A, 10B, or 10C to have increased stability if all the wheels were actively engaged in an all-wheel drive mode. In various embodiments these other types of road conditions may be compared to previously-defined thresholds for triggering the all-wheel drive condition prediction.

In various embodiments the ADAS processing unit 30 may include a communication device 93 that is in data communication with the processor 90. The computer-executable instructions are further configured to cause the processor 90 to communicate with a road weather data system 98 via a wireless connection between the communication device 93 and a network 97. The road weather data system 98, also known as a road weather information system (RWIS), may produce weather related road condition information, such as, without limitation, snow, rain, ice, or the like. The data network 97 may be a public or private data network. The computer-executable instructions within the memory 92 or 96 may cause their respective processors 90 or 94 to generate a wheel signal responsive to the weather related road condition information having a value indicating a change in wheel engagement status. In such embodiments, the weather related road condition information may include information of an upcoming section of road includes icy road conditions. Thus, the wheel signal would be generated to engage previously disengaged wheels prior to arrival the identified icy road section.

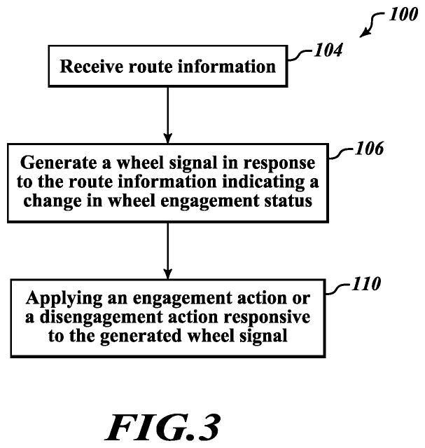

Referring additionally to FIG. 3, in various embodiments an illustrative process 100 is provided for controlling stability of a vehicle. In some such embodiments wheels of the vehicle may be engaged or disengaged responsive to route information. In various embodiments, at a block 104 route information is received from a sensor. At a block 106, a wheel signal is generated responsive to the route information indicating a change in wheel engagement status. At a block 110, an action chosen from an engagement action or a disengagement action is applied responsive to the generated wheel signal.

In some embodiments, information from an imaging device is received and the route information may be generated responsive to the information from the imaging device.

In some embodiments, generating the route information responsive to the received information from the imaging device may include identifying a road curvature value.

In some embodiments, generating the wheel signal may further include generating the wheel signal responsive to the identified road curvature value having a value chosen from a value matching or a value exceeding a threshold value, thereby indicating the change in wheel engagement status.

In some embodiments, information is received from a navigation device and the route information may be generated responsive to the information from the navigation device.

In some embodiments, generating the route information responsive to the received navigation instructions may include identifying a road curvature value responsive to the received navigation instructions. Also, generating the wheel signal may further include generating the wheel signal responsive to the identified road curvature value having a value chosen from a value matching or a value exceeding a threshold value, thereby indicating the change in wheel engagement status.

The ADAS processing unit 30 may be configured to generate the curvature value responsive to three-dimensional road information and/or images of the road, possibly determined/generated/captured from a sensor(s) 50, such as the optical devices, cameras, lidar sensors, and/or electromagnetic sensors described herein. As such, the VCU 34 and/or processor 94 may output the wheel signal to the disconnects 70, 70A-B based on the ADAS processing unit 30 generating a curvature value that meets or exceeds the threshold value.

Those skilled in the art will recognize that at least a portion of the ADAS processing unit 30, the VCU 34, the sensor(s) 50, controllers, components, devices and/or processes described herein can be integrated into a data processing system. Those having skill in the art will recognize that a data processing system generally includes one or more of a system unit housing; a video display device; memory such as volatile or non-volatile memory; processors such as microprocessors or digital signal processors; computational entities such as operating systems, drivers, graphical user interfaces, and applications programs; one or more interaction devices (e.g., a touch pad, a touch screen, an antenna, etc.); and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term unit/module/controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of component (e.g., at a first time), as a second type of component (e.g., at a second time, which may in some instances coincide with, overlap, or follow a first time), and/or as a third type of component (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second component that has a second purpose and then, a third component that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different components in as little as a few nanoseconds. A component may reconfigure on-the-fly, e.g., the reconfiguration of a component from a first component into a second component may occur just as the second component is needed. A component may reconfigure in stages, e.g., portions of a first component that are no longer needed may reconfigure into the second component even before the first component has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a component for displaying graphics on a screen, a component for writing data to a storage medium, a component for receiving user input, and a component for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components, the example includes the possibility that the same hardware may implement more than one of the recited components, either contemporaneously or at discrete times or timings. The implementation of multiple components, whether using more components, fewer components, or the same number of components as the number of components, is merely an implementation choice and does not generally affect the operation of the components themselves. Accordingly, it should be understood that any recitation of multiple discrete components in this disclosure includes implementations of those components as any number of underlying components, including, but not limited to, a single component that reconfigures itself over time to carry out the functions of multiple components, and/or multiple components that similarly reconfigure, and/or special purpose reconfigurable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A system comprising:
a sensor configured to generate route information; and
a control unit comprising:
a processor in signal communication with the sensor; and
a memory configured to store computer-executable instructions configured to cause the processor to:
receive the generated route information;
generate a wheel signal responsive to the received route information indicating a change in wheel engagement status; and
output the wheel signal to a disconnect.

2. The system of claim 1, wherein:
the sensor includes an imaging device configured to generate the route information;
the computer-executable instructions are further configured to cause the processor to generate a curvature value responsive to the generated route information; and
the generated curvature value having a value chosen from a value matching and a value exceeding a threshold value, thereby indicating the change in wheel engagement status.

3. The system of claim 2, wherein the imaging device includes an optical device configured to generate the route information, the route information including three-dimensional road information.

4. The system of claim 3, wherein the optical device includes a camera configured to generate the route information, the route information including an image of a road.

5. The system of claim 3, wherein the optical device includes a lidar sensor configured to generate the route information, the route information including three-dimensional road information.

6. The system of claim 2, wherein the imaging device includes an electromagnetic sensor configured to generate the route information, the route information including three-dimensional road information.

7. The system of claim 1, wherein the sensor includes a positioning device configured to generate the route information, the route information including road information.

8. A vehicle comprising:
a sensor configured to generate route information;
a controller unit comprising:
a processor in signal communication with the sensor; and
a memory configured to store computer-executable instructions configured to cause the processor to:
receive the generated route information;
generate a wheel signal responsive to the received route information indicating a change in wheel engagement status; and
output the wheel signal; and
a disconnect configured to apply an action chosen from an engagement action and a disengagement action responsive to the outputted wheel signal.

9. The vehicle of claim 8, wherein:
the sensor includes an imaging device configured to generate the route information;
the computer-executable instructions are further configured to cause the processor to generate a curvature value responsive to the generated route information; and
the generated curvature value having a value chosen from a value matching and a value exceeding a threshold value, thereby indicating the change in wheel engagement status.

10. The vehicle of claim 9, wherein the imaging device includes an optical device configured to generate the route information, the route information including three-dimensional road information.

11. The vehicle of claim 10, wherein the optical device includes a camera configured to generate the route information, the route information including an image of a road.

12. The vehicle of claim 10, wherein the optical device includes a lidar device configured to generate the route information, the route information including three-dimensional road information.

13. The vehicle of claim 10, wherein the imaging device includes a electromagnetic device configured to generate the route information, the route information including three-dimensional road information.

14. The vehicle of claim 8, wherein the sensor includes a positioning device configured to generate the route information, the route information including road information.

15. A method comprising:
receiving route information;
generating a wheel signal responsive to the route information indicating a change in wheel engagement status; and
applying an action chosen from an engagement action and a disengagement action responsive to the generated wheel signal.

16. The method of claim 15, further comprising:
receiving information from an imaging device; and
generating the route information responsive to the information from the imaging device.

17. The method of claim 16, wherein generating the route information responsive to the received information from the imaging device includes identifying a road curvature value.

18. The method of claim 17, wherein generating the wheel signal further includes generating the wheel signal responsive to the identified road curvature value having a value chosen from a value matching and a value exceeding a threshold value, thereby indicating the change in wheel engagement status.

19. The method of claim 15, further comprising:
receiving navigation information from a navigation device; and
generating the route information responsive to the navigation information from the navigation device.

20. The method of claim 19, wherein:
generating the route information responsive to the received navigation information includes identifying a road curvature value responsive to the received navigation information; and
generating the wheel signal further includes generating the wheel signal responsive to the identified road curvature value having a value chosen from a value matching and a value exceeding a threshold value, thereby indicating the change in wheel engagement status.
